(19) United States
(12) Patent Application Publication
(10) Pub. No.: US 2021/0110467 A1
(43) Pub. Date: Apr. 15, 2021

(54) SYSTEM FOR AN ONLINE REVERSE AUCTION USING REAL-TIME PROCESSING

(71) Applicant: Mohammad Matouq Alawwad, Kuwait City (KW)

(72) Inventor: Mohammad Matouq Alawwad, Kuwait City (KW)

(21) Appl. No.: 16/601,815

(22) Filed: Oct. 15, 2019

(51) Int. Cl. G06Q 30/08; G06Q 30/06

(52) U.S. Cl. CPC G06Q 30/08; G06Q 30/0641

(57) ABSTRACT

A system for online reverse auctioning is disclosed comprising a consumer selecting a good or service and submitting a request to a database for the selected good or services. The request is then submitted to the database wherein a provider receives the request for the good or service and submits a bid for the good or service submitted by the consumer. The consumer then selects a bid and purchases the good or service based on the bid amount or the bid terms.

### TECHNICAL FIELD

The embodiments generally relate to systems for allocating charitable contributions.

### BACKGROUND

Online auctions have become a common approach for buying and selling goods and services. Using a free-market approach, online auctions allow consumers and providers to assess the actual market value of goods and services. Most auction systems are structured as a forward auction, wherein the seller of the good or service creates an auction listing to permit consumers to bid on the auction items in the listing. It is most common for the highest bidder to win the auction.

Reverse auctions operate by allowing the buyer to create the auction listing, which functions as a request for a goods or service which they would like to purchase. The provider of the good or service then places a bid for a price and/or terms and conditions for rendering the good or service. In general, the lowest bidder is often the winner of the auction.

Reverse auctions have the advantage of providing the consumer with various offers from competitors while removing the need for the consumer to individually find and communicate with the provider and receive a competitive quote for goods and services.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

The embodiments described herein provide a system for online reverse auctioning comprising a consumer selecting a good or service and submitting a request to a database for the selected good or services. The request is then sent to the database wherein a provider receives the request for the good or service and submits a bid for the good or service submitted by the consumer. The consumer then selects a bid and purchases the good or service based on the bid amount or the bid terms.

The system allows for consumers to select from a plurality of goods and services provided in an online interface and submit a request to purchase the good(s) and/or service(s). The request is submitted to the database which displays the request to providers who may bid on the good or service. In such, the providers may view bids from other providers to allow the provider to submit a competitive bid. This allows the consumer to receive competitive bids from the providers and decide on which bid they would like to select. This allows the consumer to receive competitive offers from various providers and select their preferred offer.

In one aspect, a payment processing system is utilized to execute payment for the good or service purchased by the consumer.

In one aspect, a consumer request interface is viewable by the provider to view the requests submitted by consumers.

In one aspect, a consumer request vendor information interface is utilized to view bids submitted by a plurality of providers for the request.

### BRIEF DESCRIPTION OF THE DRAWINGS

A complete understanding of the present invention and the advantages and features thereof will be more readily understood by reference to the following detailed description when considered in conjunction with the accompanying drawings wherein:

FIG. 1 illustrates a screenshot of the consumer request interface, according to some embodiments;

FIG. 2 illustrates a screenshot of the consumer request interface, according to some embodiments;

FIG. 3 illustrates a screenshot of the provider bid interface, according to some embodiments;

FIG. 4 illustrates a screenshot of the provider bid interface, according to some embodiments; and

FIG. 5 illustrates a flowchart of the consumer user flow, according to some embodiments; and

FIG. 6A illustrates a flowchart of the reverse auction system, according to some embodiments;

FIG. 6B illustrates a flowchart of the reverse auction system, according to some embodiments; and

FIG. 7 is an exemplary block diagram of the network infrastructure, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Before describing in detail exemplary embodiments, it is noted that the embodiments reside primarily in combinations of components and procedures related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a system for providing a reverse auction via the Internet. A user who wants to purchase a good or service (i.e., the consumer) selects one or more goods and/or services for which a request is transmitted. Providers of the goods or services (i.e., the provider) receive the request and may transmit a bid for the good or service. Providers may view bids submitted by other providers to inform their decision when selecting a competitive price for the good or service.

The system may be utilized in various industries such as, for example, automotive rentals, hotels, and hospitality, automotive parts, electronics, insurance, children's toys, sporting goods, among others. The system allows the consumer to quickly receive bids from various providers without needing to research and contact individual providers.

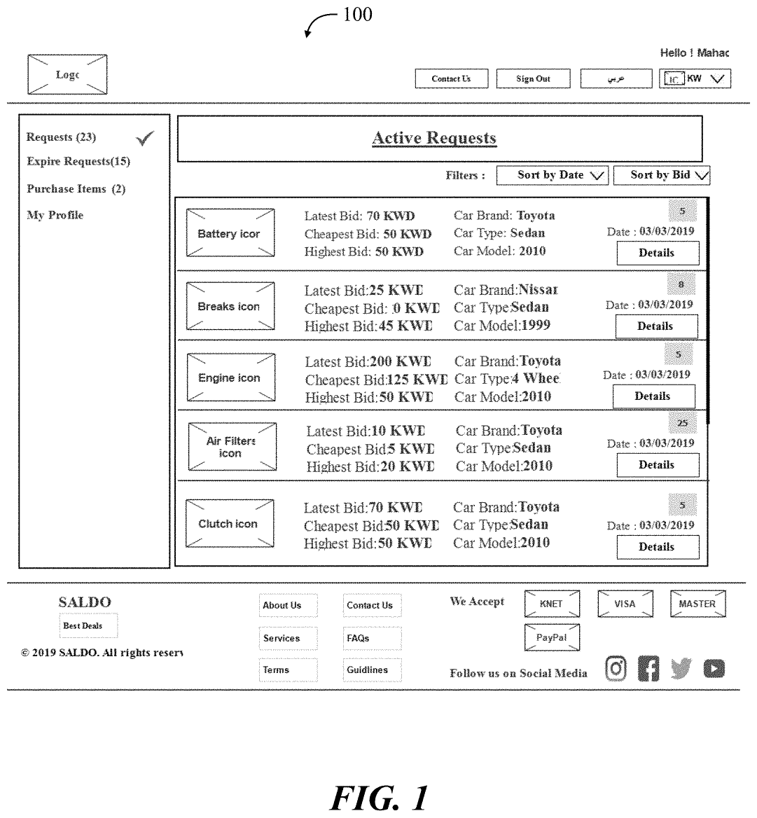

FIG. 1 illustrates a screenshot of the consumer request interface 100 comprised of a plurality of item information for which the user has created a listing. The consumer request interface is comprised of a plurality of goods or services for which the user has indicated they would like to purchase. For example, the latest bid, cheapest bid, and highest bid amounts may be illustrated for the consumer's consideration. In addition, the goods or services details, such as vehicle make, model, and type, may be shown.

In some embodiments, the bid can include a price minimum, a price maximum, and a time period during which the good or service is rendered.

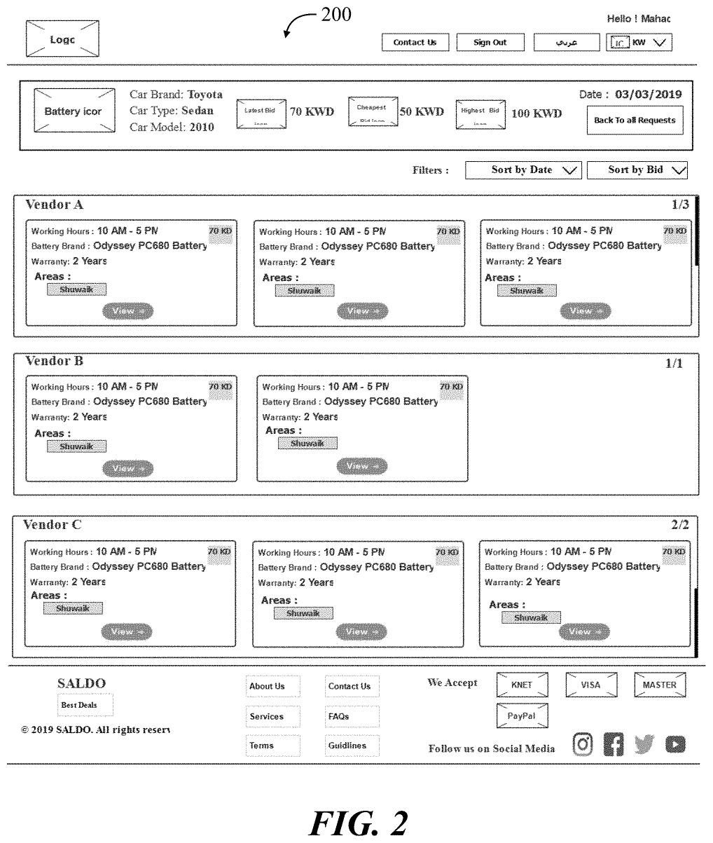

FIG. 2 illustrates the consumer request vendor information interface 200 wherein a plurality of vendor information is illustrated. The consumer request vendor information interface 200 may illustrate information for each vendor, such as hours of operation, warranty information, location, and other useful information.

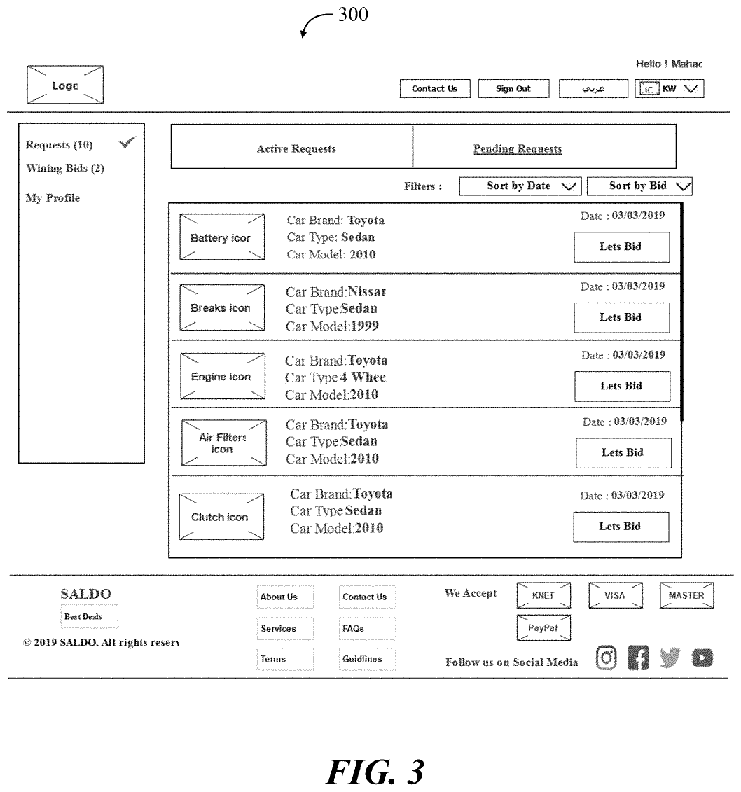

FIG. 3 illustrates a screenshot of the provider bid interface 300, which the provider of goods and/or service may utilize to view bids requests submitted by the consumers. The provider may then choose to bid for the requests good or services. For example, the provider receives a bid request for vehicle make, model, and year. The provider can then select to bid for a sale price for the item which is transmitted to the consumer for consideration.

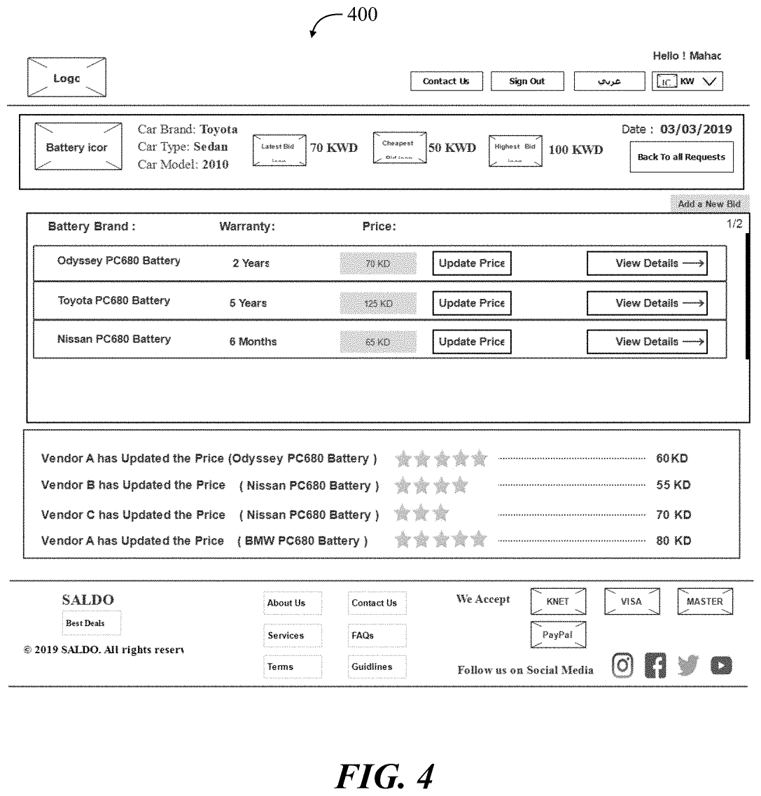

FIG. 4 illustrates a screenshot of the provider bid listing interface 400 wherein the provider may view the bids and ratings of other providers who have bid on a requested good or service by the consumer. The provider bid listing interface 400 may show the updates on the bids submitted by each of the providers. In one example, a plurality of batteries are listed for vehicles. The batteries have been requested by one or more consumers to allow the provider to bid on the price to compare the price to other providers.

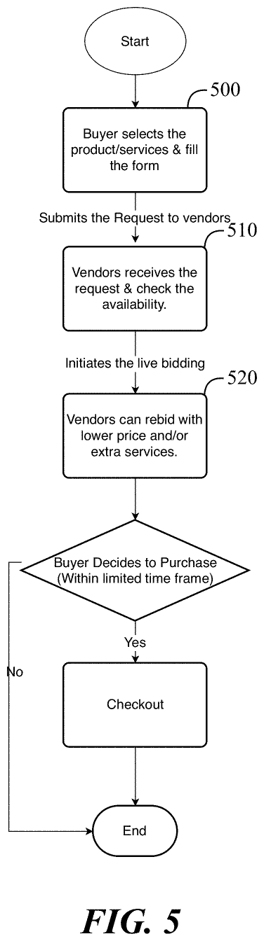

FIG. 5 illustrates a flowchart of the consumer user flow. In step 500, the consumer (buyer) selects the product and/or service and fills in information thereof. In step 510, the provider receives the request and checks the availability of the requested good and/or service. In step 520, once live bidding is initiated, the vendor can bid and rebid on the good or service requested by the provider. If the consumer decides to purchase the good or service from a particular provider, the consumer pays for the good or service using the system described herein.

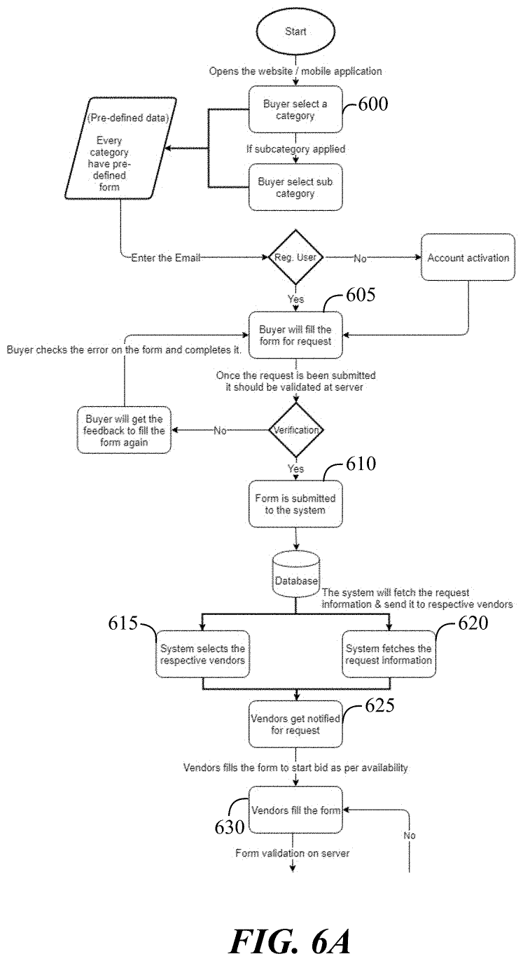

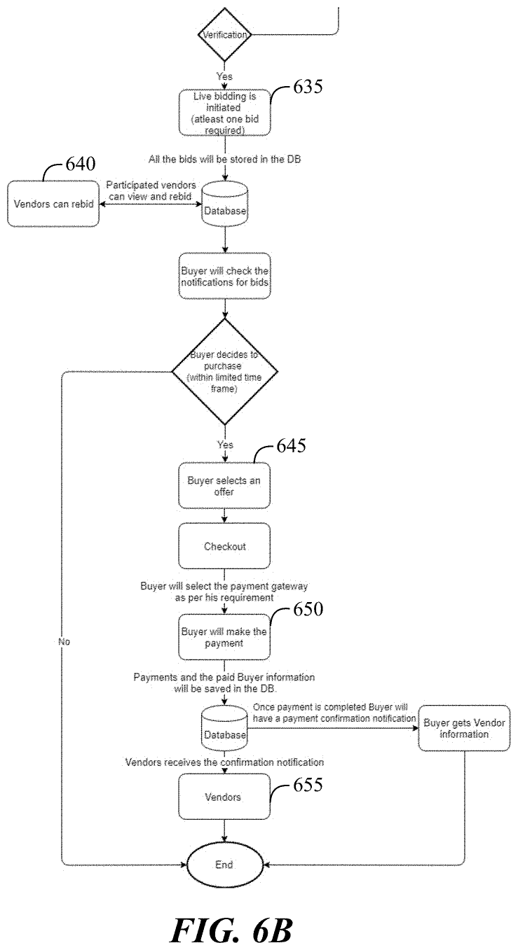

FIGS. 6A and 6B illustrate a flowchart of the reverse auction system. In step 600, the consumer selects a category of goods and/or services and may select one or more optional subcategories. In step 605, the consumer fills a form request and submits the request to the system in step 610, such that the form is stored in the database. The form request may be verified by the provider or an administrator of the system. In steps 615 and 620 the system selects the providers which have been selected by the provider and receives the request information. In step 625, the provider receives a notification of the request, and the vendor fills the form in step 630. In step 635, bidding is initiated for the consumer request and a plurality of provider bids may be received. In step 640, vendors may rebid if they choose to change the original bid amount or bid terms. In step 645, the consumer selects to purchase the good or service by selecting a bid from a provider. In step 650, the consumers pay for the good and service and receive provider information before receiving the confirmation of purchase in step 655,

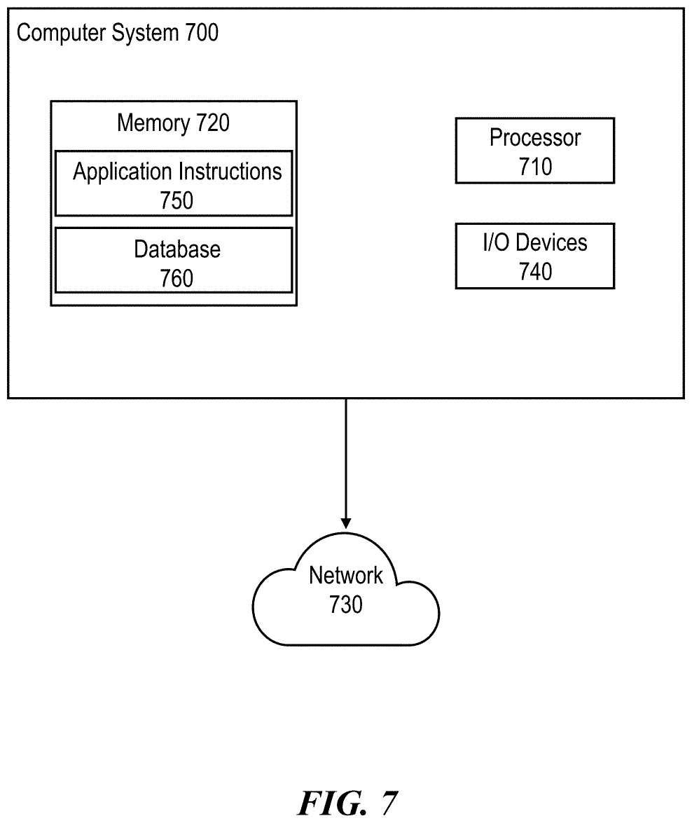

FIG. 7 illustrates a computer system 700, which may be utilized to execute the processes described herein. The computing system 700 is comprised of a standalone computer or mobile computing device, a mainframe computer system, a workstation, a network computer, a desktop computer, a laptop, or the like. The computer system 700 includes one or more processors 710 coupled to system memory 720 via an input/output (I/O) interface. Example computer system 700 further includes a network interface to communicate with the network 730. One or more input/output (I/O) devices 760, such as video device(s) (e.g., a camera), audio device(s), and display(s) are in operable communication with the computer system 700. In some embodiments, similar I/O devices 740 may be separate from computer system 700 and may interact with one or more nodes of computer system 700 through a wired or wireless connection, such as over the network interface.

Processors 710 suitable for the execution of a computer program include both general and special purpose microprocessors and any one or more processors of any digital computing device. The processor 710 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 700 and other devices attached to a network, such as other computer systems, or between nodes of the computer system 700. In various embodiments, the network interface may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

The memory 620 may include application instructions 750, configured to implement certain embodiments described herein, and a data storage 760, comprising various data accessible by the application instructions 750. In an embodiment, the application instructions 650 may include software elements corresponding to one or more of the various embodiments described herein. For example, application instructions 750 may be implemented in various embodiments using any desired programming language, scripting language, or combination of programming languages and/or scripting languages (e.g., C, C++, C#, JAVA®, JAVASCRIPT®, PERL®, etc.). The data storage 760 may include data that may be used in these embodiments. In other embodiments, other or different software elements and data may be included.

The steps and/or actions of the system described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor such that the processor can read information from, and write information to, the storage medium. In the alternative, the storage medium may be integrated into the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for online reverse auctioning, the system comprising:
a consumer selecting a good or service and submitting a request to a database for the selected good or services;
a provider to receive the request for the good or service and submitting a bid for the good or service submitted by the consumer, the consumer selecting a bid and purchasing the good or service based on the bid amount or the bid terms.

2. The system of claim 1, further comprising a payment processing system to execute payment for the good or service based on the bid selected by the consumer.

3. The system of claim 1, further comprising a consumer request interface viewable by the provider to view the request.

4. The system of claim 3, further comprising a consumer request vendor information interface wherein the provider views bids submitted by a plurality of providers for the request.

5. A method for online reverse auctioning, the method comprising the steps of:
selecting, via a consumer, a good or service and submitting a request to a database for the selected good or services;
submitting, via the consumer, a form to be stored in a database;
selecting a plurality of vendors;
receiving the information for the request;
notifying a provider of the request;
submitting, via the provider, a bid on the requested good or service;
selecting, via the consumer, the bid desired for the requested good or service;
purchasing, via the consumer, the good or service from the provider.

6. The method of claim 5, further comprising a payment processing system to execute payment for the good or service based on the bid selected by the consumer.

7. The method of claim 5, further comprising a consumer request interface viewable by the provider to view the request.

8. The method of claim 7, further comprising a consumer request vendor information interface wherein the provider views bids submitted by a plurality of providers for the request.
